(19) United States
(12) Patent Application Publication
(10) Pub. No.: US 2017/0166426 A1
(43) Pub. Date: Jun. 15, 2017

(54) HOIST DEVICE FOR A SCAFFOLD

(71) Applicants: Jesper Ryberg Lonardi, Ringsted (DK); Michal Józef Leonhard, Gorzyce Wielkie (PL); Lukasz Józef Leonhard, Gorzyce Wielkie (PL); Szymon Józef Leonhard, Gorzyce Wielkie (PL)

(72) Inventors: Jesper Ryberg Lonardi, Ringsted (DK); Michal Józef Leonhard, Gorzyce Wielkie (PL); Lukasz Józef Leonhard, Gorzyce Wielkie (PL); Szymon Józef Leonhard, Gorzyce Wielkie (PL)

(21) Appl. No.: 15/116,807

(22) PCT Filed: Feb. 4, 2015
(86) PCT No.: PCT/DK2015/050025

§ 371 Date: Aug. 4, 2016

(30) Foreign Application Priority Data
Feb. 4, 2014 (DK) PA 2014 70054

(51) Int. Cl. B66F 11/04; E04G 5/16; E04G 5/14; E04G 1/20

(52) U.S. Cl. CPC B66F 11/04; E04G 1/20; E04G 5/16; E04G 5/141; E04G 1/24

(57) ABSTRACT

A set of parts for providing a hoist (1, 101, 102) for a scaffold, the set of parts comprising a platform (2) adapted for carrying at least one object and comprising at least two gear elements (63, 64), the at least two gear elements being arranged at each of two opposing sides (25, 26) of the platform, two frames (31, 32) adapted for being arranged at each of the two opposing sides of the platform, the two frames each comprising one rack element (310, 320) arranged extending in a longitudinal direction (L) of the frame, and one motor (4) for moving the platform along a longitudinal direction of the two frames and for controlling the movement of the platform synchronously with respect to each of the two frames.

The present invention relates in a first aspect to a set of parts for providing a hoist for a scaffold and in a second aspect to a hoist for scaffold built up of such a set of parts. In a third aspect the invention furthermore relates to a method for building up a hoist for a scaffold.

As used herein the terms “scaffold” and “scaffolding” is intended to refer to a platform or framework used to support workers and materials during construction and maintenance of buildings and other like structures. The parts of such a scaffold are traditionally metal or wooden tubes and wooden plates.

Hoists for scaffolds are commonly known and widely used in connection with assembling scaffolds for hoisting scaffold parts. Hoists for scaffolds are also widely used for hoisting materials and persons in connection with the work subsequently performed by workers working on a scaffold. Hoists for scaffolds may take different forms and shapes depending on their functionally and placement in the scaffold.

Most known hoists for scaffolds use hydraulic driving means for driving the hoist. Such hoists are both heavy in structure and expensive in operation.

Also, most known hoists for scaffolds are made in one piece and may be collapsible or not. Such hoists for scaffolds are quite large, even when collapsed, and therefore take up much space during storage and transport and are cumbersome to transport.

These problems have been attempted solved by means of hoists for scaffolds made such that it is possible to take them apart at least to some extend.

U.S. Pat. No.4,294,332 A describes such a scaffold with a gear drive. The scaffold comprises a platform and a pair of towers. Each tower comprises a pair of rails, each rail having a toothed rack. A self-elevating platform supporting carriage is arranged on each tower. Each carriage comprises an electrical motor and a shaft with a pair of gears for meshing with the racks. The motors are adapted for rotating the shafts independently of or in synchronism with each other.

However, several problems unfortunately remain in connection with this type of scaffold or hoist for a scaffold. Particularly, the prior art hoists for scaffolds are complicated and time consuming to build and to take apart to the extend that one can take them apart at all. Likewise they are difficult to build together with an existing scaffold or parts thereof. Also, they are heavy and therefore difficult and cumbersome to transport, even when taken apart. Finally, the operation of the prior art hoists is energy consuming and it is complicated to synchronise the movement of the motors with respect to each other.

BE 623432, which was published on 10 Oct. 1962, describes an attempt at solving these problems by means of a scaffold made by assembling a number of elements which may subsequently be disassembled. The scaffold comprises a platform and two frames. The frames are elements made of bars, and have two posts and a rack element. The rack elements each consist of a bar in one piece with a number of equally spaced teeth. Two carriages or slides, each held by a gear wheel, are sliding on the rack elements and are driven by an electric motor. The carriages or slides are guided by means of pulleys engaging with the side surfaces of the rack elements and the platform is mounted on the carriages or slides. The motor is mounted on the platform displaced towards a side of the platform and a transmission comprising multiple components transmits the motor's force from motor to gear wheels. However, due to the construction of the scaffold and interaction of the various elements thereof this solution does not provide for a sufficiently synchronized and thus sufficiently energy efficient movement of the platform with respect to each of the two frames.

Furthermore, new safety regulations recently brought into force in at least in some countries including most European countries require i.a. that persons being hoisted up or down on hoists for a scaffold must be enclosed in such a way that they cannot fall off of the hoist. Therefore a desire to provide a new hoist for a scaffold meeting these new safety regulations has arisen.

It is the object of the invention to provide a set of parts for providing a hoist for a scaffold which is lightweight, which is easy to assemble and to take apart, which is easy to store and transport, which may be operated in an energy saving manner and which furthermore meet the above-mentioned new safety regulations.

According to the invention, this is obtained by means of a set of parts for providing a hoist for a scaffold comprising a platform adapted for carrying at least one object and comprising at least two gear elements, the at least two gear elements being arranged at each of two opposing sides of the platform, two frames adapted for being arranged at each of the two opposing sides of the platform, the two frames each comprising one rack element arranged extending in a longitudinal direction of the frame, and one motor for moving the platform along a longitudinal direction of the two frames and for controlling the movement of the platform synchronously with respect to each of the two frames, the rack element of each of the two frames comprising a toothed rack, and each of the gear elements of the platform comprising a gear, the toothed rack and the gear being adapted for mutual engagement, and wherein the rack element of each of the two frames further comprises a first profile element adapted for accommodating the toothed rack, and each of the gear elements of the platform comprises a second profile element being adapted for accommodating the gear and for sliding engagement with one of the respective first profile elements.

By providing the rack element of each of the two frames with a toothed rack and each of the gear elements of the platform with a gear, the toothed rack and the gear being adapted for mutual engagement, a particularly simple and robust connection between the platform and the two frames is provided for.

By providing the rack element of each of the two frames with a first profile element adapted for accommodating the toothed rack, and each of the gear elements of the platform with a second profile element being adapted for accommodating the gear and for sliding engagement with one of the respective first profile elements, the connection between the platform and the two frames is enforced further while simultaneously providing for a particularly straight-forward way of connecting the platform and the two frames. This in turn provides for an improvement of the synchronization of the movement of the platform with respect to each of the two frames.

By providing each of the two frames with one rack element arranged extending in a longitudinal direction of the frame, a set of parts is provided with which a hoist with a simple and light yet sturdy structure may be built.

By providing one motor for moving the platform along a longitudinal direction of the two frames, which motor controls the movement of the platform synchronously with respect to each of the two frames, a set of parts is provided with which a hoist which may be operated in an energy saving manner may be built. Further energy is saved in virtue of the structure being considerably lighter, also as only one motor is needed, than the prior art structures.

In an embodiment the motor is attached to the platform and the platform further comprises a transmission element for driving each of the at least two gear elements, the transmission element extending from the motor and being connected to each of the at least two gear elements.

Thereby a set of parts is provided with which the transmission of driving power from the motor to the platform may follow in a very simple manner using as few elements as possible. This in turn contributes to keeping down the weight of a hoist built up of such a set of parts.

In an embodiment the motor is arranged under the platform. Thereby a set of parts is provided with which the motor may be arranged screened from the surroundings. In an embodiment, the motor may be arranged centrally on or under the platform. Thereby a set of parts is provided with which the equilibrium of the platform in a hoist built of such a set of parts may be maintained.

In an embodiment the one rack element of each of the two frames is arranged centrally on the frame.

By providing the rack element centrally on the frame the structure of the frame is further simplified and thus a set of parts is provided which is furthermore made considerably simpler to assemble to a hoist for a scaffold and to take apart.

In an embodiment at least one of the two frames comprise any one or more of at least one longitudinal frame element arranged by a side of the rack element and extending substantially parallel with the rack element, and at least one transversal frame element extending substantially perpendicular to the rack element.

In a particular embodiment at least one of the two frames comprise any one or more of at least two longitudinal frame elements arranged by each side of the rack element and extending substantially parallel with the rack, and at least one transversal frame element arranged substantially perendicular to the rack element and extending between the at least two longitudinal frame elements.

By any of the two above embodiments a set of parts is provided with which a hoist which is particularly stable and robust may be built up, the second mentioned embodiment further improving the robustness and stability of the first mentioned embodiment. Also such a hoist may transport more weight at the time than the prior arts hoists.

The motor may be any suitable type of motor. In a specific embodiment, however, the motor is an electric motor, such a motor having a particularly low energy consumption. In practice it has been shown that a motor with a driving power of 800 W is sufficient for moving the platform of a hoist according to the invention.

In an embodiment the platform further comprises a compartment adapted for accommodating the motor, the compartment being arranged substantially centrally under the platform.

Thereby the motor may be arranged screened from the surroundings such as to ensure that water, dust and other impurities and unwanted substances interfere with the motor.

In an embodiment the set of parts further comprises a braking element adapted for braking the movement of the platform along the longitudinal direction of the two frames when the speed of the platform exceeds a predefined threshold, the braking element being of the type comprising a gear wheel with an internal brake mechanism.

Such a braking element improves the safety of a hoist built from such a set of parts in that it ensures that the platform is prevented from bolting.

In an embodiment the set of parts further comprises any one or more of:

a rail element adapted for enclosing the platform and optionally comprising a door element which comprises a first part and a second part, the second part being arranged in the first part such as to be telescopically slidable with respect to the first part between a collapsed position and an extended position and the second part being biased towards the extended position with a biasing force of between 40 and 50 N,

at least one frame extension element adapted for connection with one of the two frames such as to extend the one of the two frames in the longitudinal direction,

at least one first supporting element adapted for extending between the two frames,

at least one second supporting element adapted for extending between one of the two frames and a base on which the two frames are arranged, and

at least one wheel adapted for connection with one of the two frames and for rolling on a base on which the two frames are arranged.

By providing at least one frame extension element a set of parts is provided with which a hoist may be built with which adaptation of the height of the hoist is made particularly simple.

By providing a rail element adapted for enclosing the platform a set of parts is provided with which a hoist which meets the new safety regulations mentioned above is provided for. Advantages relating to the optional door element appear from the detailed description.

By providing at least one first supporting element and/or at least one second supporting element a set of parts is provided with which a hoist which is particularly stable and robust may be built up. Also such a hoist may transport considerably more weight at the time than the prior arts hoists.

By providing at least one wheel a set of parts is provided with which a hoist which is particularly simple to transport in its assembled state may be built.

According to a second aspect of the invention the object is achieved by a hoist for a scaffold built up of a set of parts according to the first aspect of the invention the hoist comprising:

a platform adapted for carrying at least one object and comprising at least two gear elements, the at least two gear elements being arranged at each of two opposing sides of the platform,

two frames each comprising one rack element arranged extending in a longitudinal direction of the frame, the two frames being arranged at each of the two opposing sides of the platform such that the rack element of each of the at least two frames is in mutual engagement with at least one of the at least two gear elements, and

one motor for moving the platform along a longitudinal direction of the two frames, the motor being connected to the at least two gear elements of the platform such as to control the movement of the platform synchronously with respect to each of the two frames.

According to a third aspect of the invention the object is achieved by a method for building up a hoist for a scaffold, the method comprising the steps of:

providing a set of parts according to the first aspect of the invention,

placing the two frames at each of two opposing sides of the platform such that the respective rack element of the two frames extend substantially vertically, and

arranging the platform such that the two gear elements of the platform are brought into engagement with the respective rack element of the two frames.

The invention will be described in more detail below by means of a non-limiting example of a presently preferred embodiment and with reference to the schematic drawings, in which:

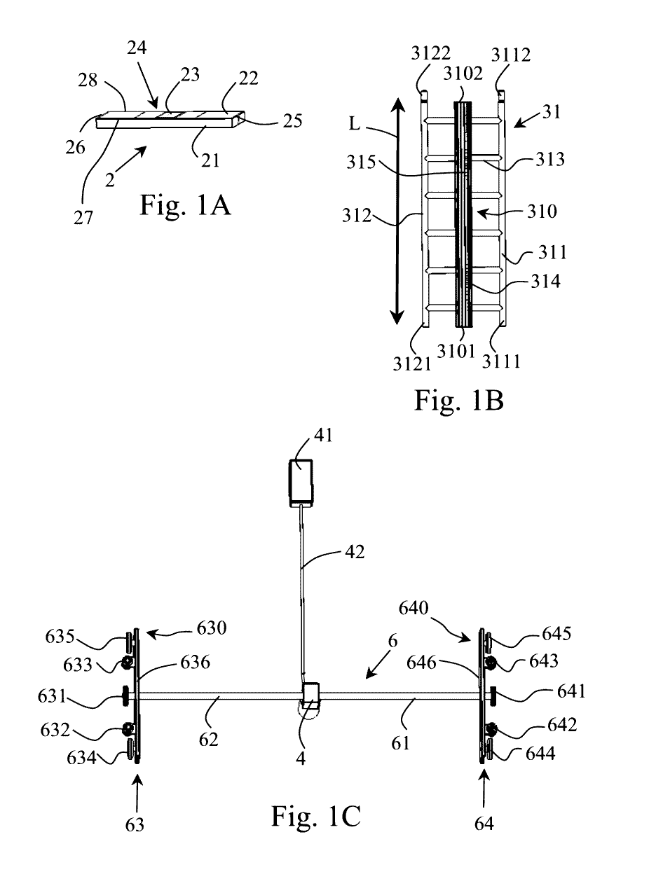

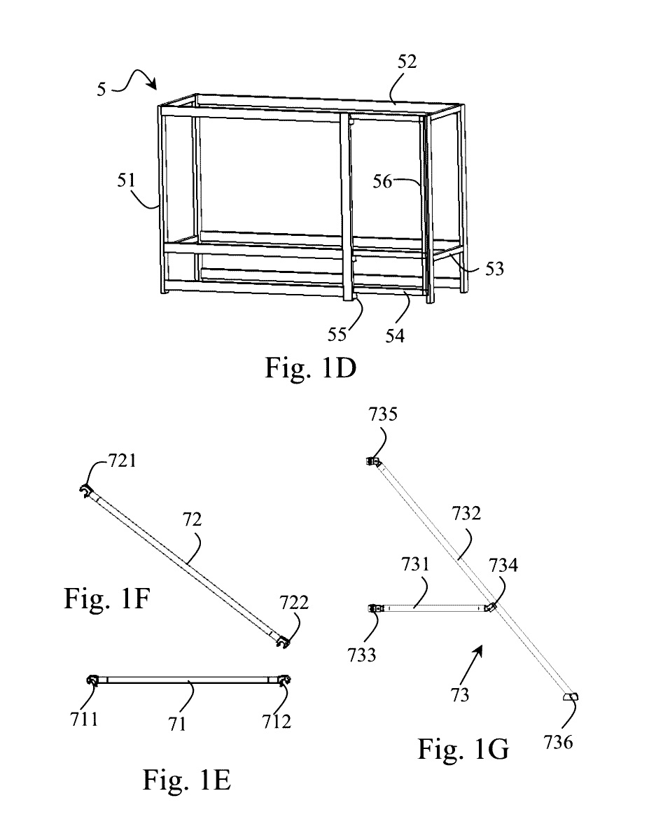

FIGS. 1A to 1G shows schematic views of different parts of an embodiment of a set of parts according to the first aspect of the invention,

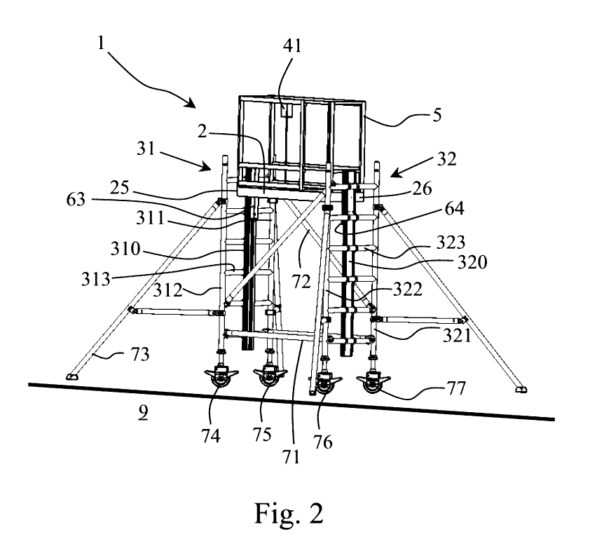

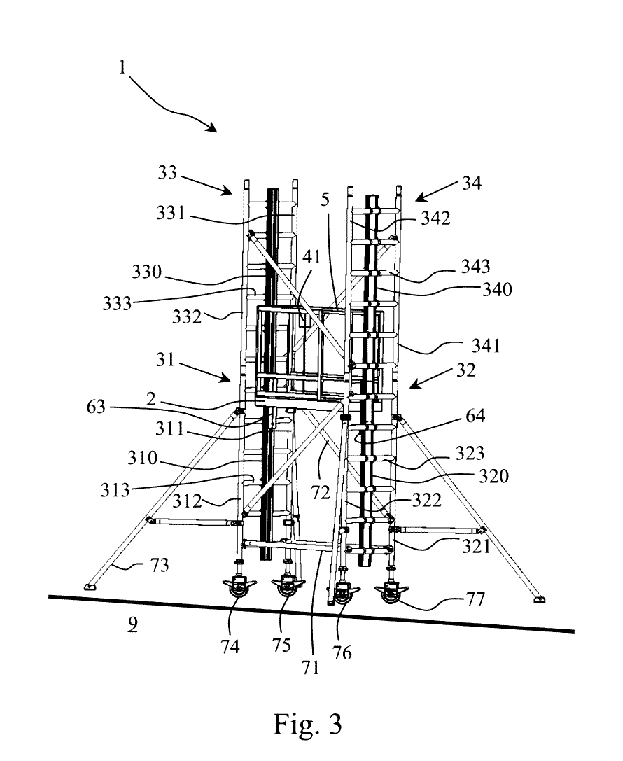

FIGS. 2 and 3 shows schematic views of a hoist for a scaffold according to the second aspect of the invention,

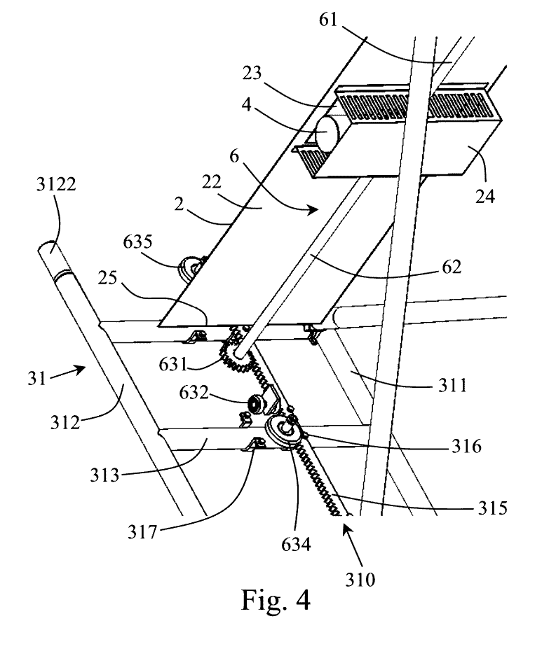

FIG. 4 shows a schematic view of a detail of a hoist for a scaffold according to the second aspect of the invention,

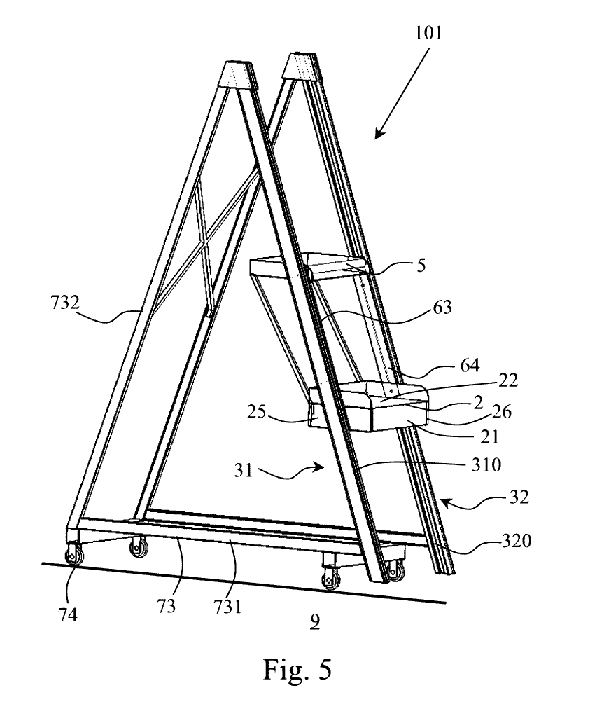

FIG. 5 shows a schematic view of a second embodiment of a set of parts according to the first aspect of the invention assembled to form a ladder-shaped hoist,

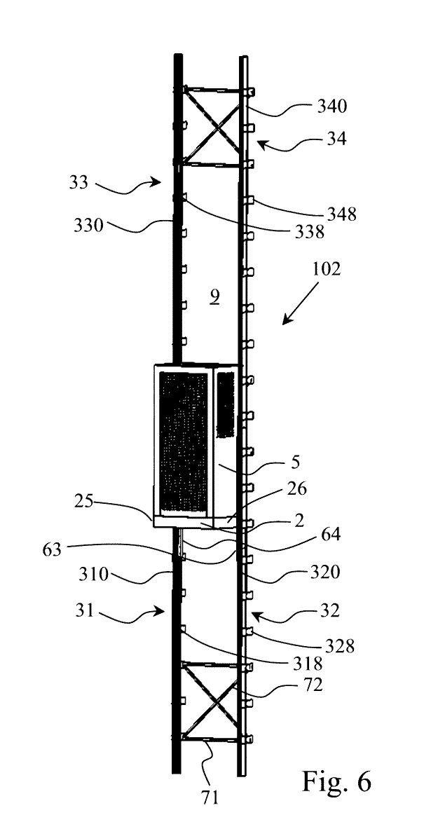

FIG. 6 shows a schematic view of a third embodiment of a set of parts according to the first aspect of the invention assembled to form a hoist adapted for use in the interior of a construction,

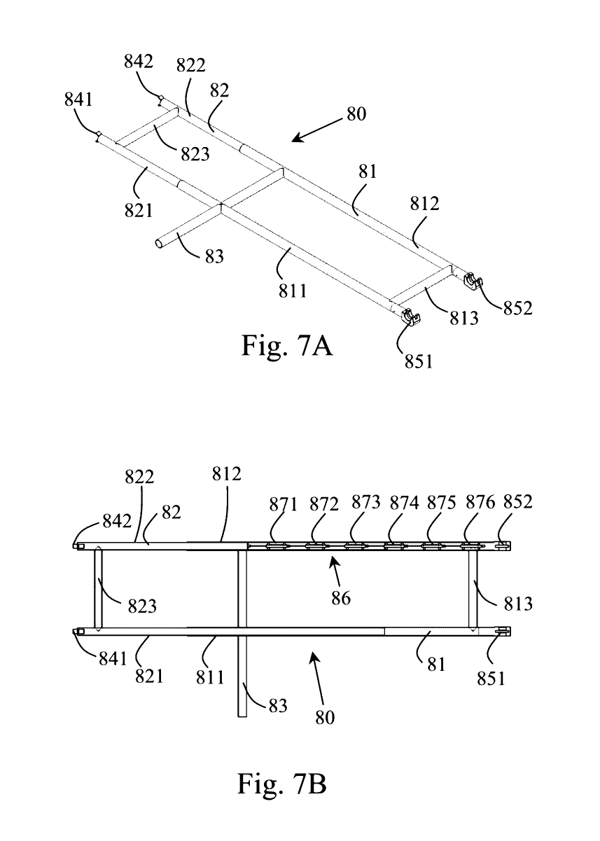

FIG. 7A shows a schematic view of a door element which may form part of a set of parts according to the first aspect of the invention, FIG. 7B shows a cross sectional view of the door element according to FIG. 7A,

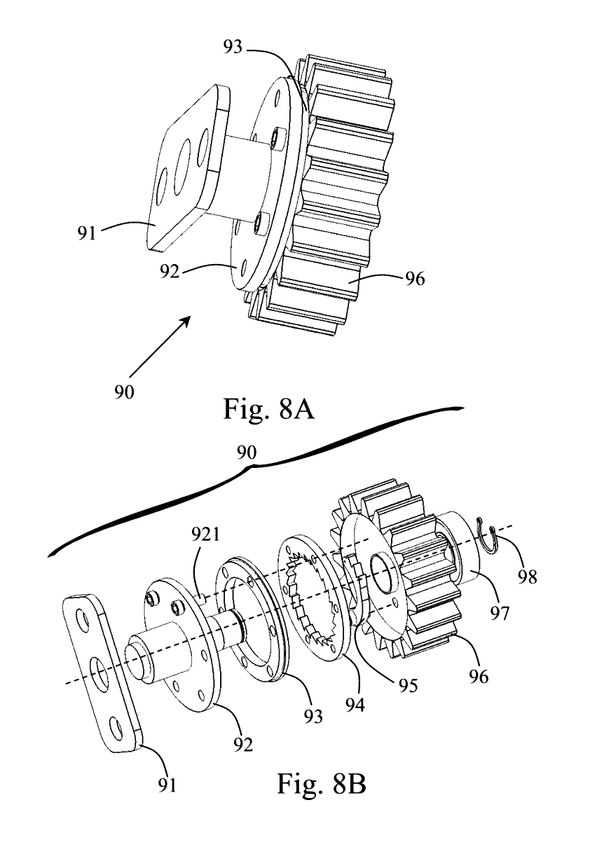

FIG. 8A shows a schematic view of a braking element which may form part of a set of parts according to the first aspect of the invention, and

FIG. 8B shows an exploded view of the braking element according to FIG. 8A.

FIGS. 1A to 1G show the various elements of a set of parts according to the invention. In FIGS. 2 and 3 is shown a perspective view of a hoist 1 for a scaffold according to the second aspect of the invention. Such a hoist 1 for a scaffold is constructed by means of a set of parts according to the first aspect of the invention.

With reference to FIG. 1A-1C, the set of parts comprises a platform 2, two frames 31, 32 and a motor 4.

An embodiment of a platform 2 is shown in FIG. 1A. The platform 2 is adapted for carrying at least one object. In this connection and as used herein the term “object” is intended to encompass any object which it may be desired to hoist to a given level of a scaffold, including but not limited to, persons, scaffold parts, building materials of any kind, tools of any kind and the like.

The platform 2 comprises a circumferential wall 21 and a plate 22. The plate 22 is provided with a lid 23, which may be any type of lid such as e.g. a hinged lid, a slidable lid or a snap-locking lid. The lid 23 forms an access to a compartment 24 for accommodating the motor 4. The platform 2 further comprises opposing sides 25 and 26 as well as opposing sides 27 and 28.

In the embodiment shown the platform 2 is rectangular in cross section. The platform 2 may, however, just as well have any other cross sectional shape such as square, polygonal, elliptic or circular. Hence, the term “opposing sides” as used herein is intended to refer both to two sides of the platform 2 extending parallel to one another as well as two diametrically opposite sides of a platform with e.g. an elliptic or circular cross section.

The platform 2 further comprises two gear elements 63 and 63. The two gear elements 63, 64 are arranged at each of the two opposing sides 25 and 26 of the platform 2 (cf. FIG. 2). In principle, the two gear elements 63, 64 may just as well be arranged at each of the two opposing sides 27 and 28 of the platform 2. The gear elements 63 and 64 are shown in greater detail in FIG. 1C and will be described further below.

An embodiment of a frame 31 is shown in FIG. 1B. The two frames 31 and 32 are identical and are furthermore adapted for being arranged at each of two opposing sides 25, 26 or 27, 28 of the platform 2, particularly at the two opposing sides 25 and 26 at which the gear element 63 and 64 are arranged (cf. FIG. 2).

It is noted that the set of parts may also optionally comprise two or more frame extension elements 33, 34 (cf. FIG. 3), which are in the embodiments shown identical to the frame 31 shown in FIG. 1B. In other embodiments the frames 31, 32 and the frame extension elements 33, 34 have two or more different constructions.

The frame 31 comprises one rack element 310 arranged extending in a longitudinal direction L of the frame 31 and centrally on the frame 31. The rack element 310 comprises a profile 314 and a toothed rack 315 (cf. also FIG. 4) arranged in the profile 314.

The profile 314 is adapted for sliding engagement with a profile 630, 640 (cf. FIG. 1C) of the gear element 63, 64 of the platform 2. The profile 314 is in the embodiment shown substantially U-shaped. However, the profile 314 may in principle be of any other suitable shape such as e.g. T-shaped, L-shaped, I-shaped or C-shaped. The profile 314 may furthermore comprise additional features such as additional flange(s) for improved engagement with the profiles 630, 640, or protrusions or recesses for sliding engagement with a complementary structure provided on the profiles 630, 640.

The rack element 310 further comprises a first end 3101, which may or may not be closed off such as to prevent the platform from moving too far down towards the basis 9 (cf. FIGS. 2 and 3) on which the frame is arranged. The rack element 310 further comprises a second end 3102, which is adapted for connection with the first end of the rack element of a frame extension element.

It is noted that in case of a frame extension element, both the first end and the second end of the rack element may be adapted for connection with the rack element of a further frame extension element. Alternatively, still in case of a frame extension element, the first end of the rack element may be adapted for being connected to the second end 3102 of the rack element 310 of the frame 31, whereas the second end of the rack element may be adapted for connection with the rack element of a further frame extension element.

The frame 31 further comprises two longitudinal frame elements 311 and 312 arranged by each side of and in a distance from the rack element 310 and extending substantially parallel with the rack element 310 and a plurality, as shown six, transversal frame elements 313 arranged substantially perpendicular to the rack element 310 and extending between the at least two longitudinal frame elements 311 and 312. Thereby a robust yet light-weight structure is provided. In other embodiments the longitudinal frame elements 311, 312 may be arranged adjacent to or in contact with the rack element 310.

The respective frames 31 and 32 as well as the respective frame extension elements 33 and 34, where applicable, are provided as one preassembled unit. Alternatively the longitudinal frame elements and/or the transversal frame elements may be provided as standard scaffolding elements comprising engagement ends for engagement with other standard scaffolding elements.

The two longitudinal frame elements 311 and 312 each comprise a first end 3111 and 3121, respectively, adapted for being placed directly on a basis 9 (cf. FIGS. 2 and 3) and/or for being connected to a wheel 74-77 (Cf. also FIGS. 2 and 3). The two longitudinal frame elements 311 and 312 further each comprise a second end 3112 and 3122, respectively, adapted for connection with a frame extension element 33 or 34 (cf. FIG. 3).

It is noted that in case of a frame extension element, both the first ends and the second ends of the longitudinal frame elements of the frame extension element may be adapted for connection with the first ends of the longitudinal frame elements of a further frame extension element. Alternatively, and still in case of a frame extension element, the first ends of the longitudinal frame elements of the frame extension element are adapted for being connected to the second ends 3112, 3122 of the frame 31 (or 33 as the case may be), whereas the second ends of the longitudinal frame elements of the frame extension element are adapted for connection with a further frame extension element.

An embodiment of a motor 4 and a transmission 6 is shown in FIG. 1C, in which the gear elements 63 and 64 of the platform 2 are likewise shown.

The motor 4 controls the movement of the platform 2 synchronously with respect to each of the two frames 31, 32. As may be seen in FIG. 4, the motor 4 is arranged under the platform 2 in such a way that it is not visible on FIGS. 2 and 3.

Furthermore a control device 41 for controlling the motor 4 is provided. The control device 41 may be connected to the motor 4 by means of a wired connection 42. Alternatively, the control device 41 may be connected to the motor by means of a wireless connection.

The transmission 6 comprises a transmission rod 61, 62 connecting the motor 4 with each of the gear elements 63 and 64. The transmission rod 61, 62 may be one common rod or two separate rods.

The gear elements 63 and 64 each comprise a gear 631 and 641, respectively, adapted for connection with a toothed rack 315, 325 of a rack element 310, 320 of a frame 31, 32.

The gear elements 63 and 64 further each comprise a profile 630 and 640, respectively, adapted for accommodating the respective gear 631 and 641 and for sliding engagement with a profile 314, 324 of a rack element 310, 320 of a frame 31, 32. The profiles 630, 640 are in the embodiment shown substantially U-shaped. In FIG. 1C the profiles 630 and 640 are, however, shown as a plate 636 and 646, respectively, as the legs of the U-profile has been removed for clarity purposes.

The profiles 630, 640 are adapted for sliding engagement with a respective profile 310, 320 (cf. FIG. 1B) of the frame 31, 32. Thus, the profiles 630, 640 may in principle be of any other suitable shape such as e.g. T-shaped, L-shaped, I-shaped or C-shaped. The profiles 630, 640 may furthermore comprise additional features such as additional flange(s) for improved engagement with the profiles 310, 320, or protrusions or recesses for sliding engagement with a complementary structure provided on the profiles 310, 320.

The gear elements 63 and 64 further each comprise an in principle optional set of guiding elements 632-635 and 642-645, respectively, for guiding the gear elements 63, 64 on the rack elements 310, 320. In the embodiment shown the guiding elements 632-635 and 642-645 are wheels.

Turning now to FIG. 1D, the set of parts may also optionally comprise a rail element 5 enclosing the platform 2. The rail element 5 is in the embodiment shown constructed of a plurality of substantially horizontally extending elements 52, 53, which may be rods, bars or the like, and a plurality of substantially vertically extending elements 51, which may likewise be rods, bars or the like. The rail element 5 further comprises one or more substantially horizontally extending elements 54 being connected at one end to a vertically extending element by means of hinges 55 or the like and at another end to a substantially vertically extending element 56 such as to form an entrance. As an alternative to such an entrance a door element may be provided, an example of such a door element being described below in relation to FIGS. 7A and 7B.

In an embodiment the substantially horizontally extending elements 52, 53 and the substantially vertically extending elements 51 are both provided as standard scaffolding elements comprising engagement ends for engagement with other standard scaffolding elements.

Turning now to FIGS. 1E and 1F, the set of parts may also optionally comprise one or more first supporting elements 71, 72 adapted for extending between the two frames 31 and 32 (cf. FIGS. 2 and 3). The first supporting elements 71 and 72 shown in FIG. 1E and in FIG. 1F, respectively, are identical with the exception of the respective length. The first supporting element 71 is adapted for extending between and perpendicular to the frames 31 and 32 thus forming a horizontal. The first supporting element 72 is somewhat longer and is thus adapted for extending diagonally between the frames 31 and 32 thus forming a diagonal.

The first supporting elements 71 and 72 are both provided as standard scaffolding elements comprising a first engagement end 711 and 721, respectively, and a second engagement end 712 and 722, respectively, for engagement with the frame 31, 32. Such engagement ends, whether on a first supporting element or being similar engagement ends on any other element of a set of parts according to the invention, is known as such and may be made e.g. as described in WO 2010/136044 A1.

Turning now to FIG. 1G, the set of parts may also optionally comprise one or more second supporting elements 73. The second supporting element 73 is adapted for extending between a frame 31 or 32 and the basis 9 on which the frame 31 or 32 is arranged (cf. FIGS. 2 and 3). The second supporting element 73 comprises a first part 731 and a second part 732, each provided as standard scaffolding elements comprising a first engagement end 733 and 735, respectively, for engagement with the frame 31 or 32 and a second engagement end 734 and an abutment end 736, respectively. The second engagement end 734 of the first part 731 is adapted for connection with the second part 732. The abutment end 736 of the first part 731 is adapted for abutment against the basis 9.

Furthermore, the set of parts may comprise one or more wheels 74, 75, 76, 77 (cf. FIGS. 2 and 3) adapted to be connected to the two frames 31, 32 for easy movement of the hoist on the basis 9.

The wheels 74-77 and guiding wheels 631-635 and 641-645 are in an embodiment made of a suitably durable plastic or rubber material. The rack elements 310, 320, the gear elements 63, 64 and the transmission 6 are in an embodiment made of a suitable highly durable metal such as iron or steel. All other elements of the set of parts according to the invention are in an embodiment made of a robust yet lightweight material, e.g. a metal such as aluminium, for maximum strength and durability.

Turning to FIGS. 2 and 3, perspective views of a hoist 1 according to the second aspect of the invention is shown. The hoist 1 is built up of a set of parts as described above and comprises a platform 2, two frames 31, 32 and a motor 4 which is not visible on FIGS. 1 and 2, cf. instead FIG. 4.

Referring to FIG. 2, the hoist furthermore comprises a rail element 5, four first supporting elements 71, 72 and four second supporting elements 73.

As may be seen, the gear elements 63 and 64 are brought into sliding engagement with the respective rack elements 310, 320 such as to enable the platform to move along a longitudinal direction L of the two frames.

As may also be seen, the platform 2 has been moved to the uppermost position at the top of the frames 31, 32 by operating the motor 4 by means of the control unit 41 to control the movement of the platform synchronously with respect to each of the two frames.

FIG. 3 shows the hoist 1 according to FIG. 2 now including two frame extension elements 33 and 34. The frame extension elements 33 and 34 are as mentioned identical to the frames 31 and 32. Hence the frame extension elements 33 and 34 each comprise two longitudinal frame elements 331, 332 and 341, 342, respectively, arranged by each side of the respective rack element 330, 340 and extending substantially parallel with the respective rack element 330, 340 and a plurality, as shown six, transversal frame elements 333, 343, respectively, arranged substantially perpendicular to the respective rack element 330, 340 and extending between the at least two longitudinal frame elements 331, 332 and 341, 342, respectively. Thereby a robust yet lightweight structure is provided.

Turning to FIG. 4, a perspective view of the upper left corner of the hoist 1 shown on FIG. 1 is shown. In the following the details specific to FIG. 4 will be described.

As may be seen the profiles 630 and 314 have been removed to show the toothed rack 315 and the gear 631, respectively, which are in mutual engagement.

As may furthermore be seen the toothed rack is attached to the horizontal frame elements 313 by means of attachment means 316 such as brackets. Likewise attachment means 317, such as brackets, used for attaching the profile 314 to the horizontal frame elements are shown.

Furthermore, the circumferential wall 21 of the platform 2 has been removed, such that the platform 2 now appears in its simplest form, namely a plate 22. A compartment 24 for accommodating the motor 4 is attached to the platform 2. The compartment 24 may comprise ventilation openings.

In a further embodiment, the platform 2 may comprise one or more intermediate walls arranged such that the transmission rods 61 or 62 extend through the intermediate walls. Such intermediate walls may add robustness to the structure of the platform 2 as well as help supporting the transmission rods 61 and 62.

Turning now to FIG. 5 a set of parts according to the first aspect of the invention is shown assembled to form a ladder-shaped hoist 101.

In this embodiment the platform 2 forms a rung of the ladder-shaped hoist 101, while the frames 31 and 32 form the columns of the ladder-shaped hoist 101.

The platform 2 comprises two gear elements 63 and 64, e.g. of the type described above, the two gear elements 63 and 64 being arranged at each of two opposing sides of the platform 2 and the two frames 31 and 32 each comprising one rack element 310 and 320, e.g. of the type described above, respectively, arranged extending in a longitudinal direction of the frame and centrally on the frame.

The ladder-shaped hoist 101 further comprises a rail element 5, wheels 74 for easy transport of the ladder-shaped hoist 101 and a second supporting element 73.

Turning now to FIG. 6 a set of parts according to the first aspect of the invention is shown assembled to form a hoist 102 adapted for use in the interior of a construction, such as a windmill tower.

The hoist 102 comprises a platform 2 and a rail element 5, the rail element 5 in this embodiment being a closed cage.

The hoist 102 further comprises two frames 31 and 32 arranged on opposing sides 25, 26 of the platform 2 as well as two frame extension elements 33 and 34 connected to the frames 31 and 32, respectively. The frames 31 and 32 as well as the frame extension elements 33 and 34, and thereby the hoist 102, are attached to a basis 9, here being a wall of a construction, e.g. the interior wall of a windmill tower, by means of suitable attachment means 318, 328, 338, 348.

The hoist 102 further comprises a plurality of first supporting elements 71, 72 for improved stability and durability of the hoist 102.

The platform 2 comprises two gear elements 63 and 64, e.g. of the type described above, the two gear elements 63 and 64 being arranged at each of two opposing sides of the platform 2 and the two frames 31 and 32 each comprising one rack element 310 and 320, e.g. of the type described above, respectively, arranged extending in a longitudinal direction of the frame and centrally on the frame. The two frame extension elements 33 and 34 likewise each comprise one rack element 330 and 340, respectively.

Turning now to FIGS. 7A and 7B a schematic and a cross sectional view, respectively, of a door element 80 which may form part of a set of parts according to the first aspect of the invention is shown.

The door element 80 is in the embodiment shown adapted for forming a side of the rail 5. In principle the door element 80 may, however, just as well be used in any other suitable position on a scaffold in which a door element may be needed. Hence the door element 80 is a door element for a scaffold, and in particular a door element for a hoist for a scaffold according to the second aspect of the invention.

The door element 80 comprises a first part 81 and a second part 82, the second part 82 being arranged in the first part 81 such as to be telescopically slidable with respect to the first part 81 between a collapsed position and an extended position. FIGS. 7A and 7B illustrate the extended position of the second part 82 of the door element 80. The collapsed position corresponds to the door element 80 being open and the extended position corresponds to the door element 80 being closed. The first part 81 and the second part 82 are in one embodiment made of aluminium.

The first part 81 comprises at least two longitudinal elements 811, 812 and at least one transversal element 813 connecting the longitudinal elements 811, 812. The first part 81 is made of tubular elements. At least the longitudinal elements 811, 812 of the first part 81 may in one embodiment have an outer diameter of 50 mm.

The first part 81 comprises at least one engagement end 851, 852 adapted for engagement with another element of a hoist for a scaffold, particularly the rail 5, or another element of a scaffold, as the case may be.

The second part 82 comprises at least two longitudinal elements 821, 822 and at least one transversal element 823 connecting the longitudinal elements 821, 822. The second part 82 is made of tubular elements. At least the longitudinal elements 821, 822 of the second part 82 have an outer diameter corresponding to the inner diameter of the longitudinal elements 811, 812 of the first part 81.

The second part 82 comprises at least one abutment end 841, 842 adapted for abutment with another element of a hoist for a scaffold, particularly the rail 5, or another element of a scaffold, as the case may be.

The door element 80 further comprises a connection element 83 adapted for connection with another element of a hoist for a scaffold, for instance a suitable opening in the platform 2, or another element of a scaffold, as the case may be.

The second part 82 of the door element 80 is biased towards the extended position such as to keep the door closed, the biasing force being about 50 N, alternatively between 45 and 55 N or between 40 and 50 N.

With reference particularly to FIG. 7B the door element 80 therefore further comprises a biasing device 86 for biasing the second part 82 towards the extended position such as to keep the door closed. Thereby, the security of a person standing on the platform 2 of the hoist is increased further, and it is ensured that the new safety regulations mentioned in the introductory description are met.

The biasing device 86 is adapted for enabling the door element 80 to be opened by exerting a force which in one embodiment is about 50 N. In other embodiments the opening force may be between 45 and 55 N or between 40 and 50 N. Thereby the door element 80 is easy to open and it is simultaneously ensured that it is kept safely closed when not operated.

The biasing device 86 is arranged in one of the longitudinal elements 811, 812 of the first part 81 such as to be screened from dust, water and other potentially damaging external influences.

The biasing device 86 comprises in the embodiment shown a plurality of gas dampeners 871-876. In the embodiment shown the biasing device 86 comprises six gas dampeners 871-876, although another number of gas dampeners may alternatively be provided for. The gas dampeners 871-876 are connected in series or in other words end to end to form a line of gas dampeners. This provides for a simple biasing device with which the desired low opening force may be obtained over a relatively long distance, particularly distances exceeding 0200 mm. In comparison, a single actuator of any known type used as a biasing device 86 as shown on FIG. 7B would require a force of at least 300 N in order to open the door element, such a force being considerably above the force exertable by human muscles, particularly arm muscles.

Turning now to FIGS. 8A and 8B a schematic and an exploded view, respectively, of a braking element 90 which may form part of a set of parts according to the first aspect of the invention is shown.

The braking element 90 is a braking element for a hoist for a scaffold. The braking element 90 is adapted for braking the movement of the platform 2 along the longitudinal direction of the two frames 31, 32 when the speed of the platform 2 exceeds a predefined threshold. In one embodiment this threshold is set to 10 m/minute.

The braking element 90 has a construction similar to that of a toothed pulley. Particularly, the braking element 90 is of the type comprising a gear wheel with an internal brake mechanism

With reference particularly to FIG. 8B, the braking element 90 comprises the following elements:

a fastening element 91 adapted for fastening the braking element 90 to the hoist, and particularly to the platform 2,

a connection element 92 adapted for connecting elements 92, 93, 94 and 96 of the braking element 90 to each other by means of attachment means such as bolts 921, screws, rivets or the like,

a sealing element 93, such as a ring-shaped gasket, adapted for sealing the braking element 90 such as to prevent dust, water and other potentially damaging external influences from entering the interior of the braking element 90,

a ring-shaped element 94 with an internal toothing,

a pawl element 95 adapted for engagement with the interior toothing of the ring-shaped element 94,

a gear wheel 96 adapted for engagement with the toothed rack 315, 325 of the rack element 310, 320 of one of the frames 31, 32,

a bearing element 97 adapted for ensuring that the gear wheel 96 may rotate freely when the braking element 90 is in its assembled state (FIG. 8A), and

an optional safety spring element 98 for the bearing element 97. The fastening element 91 is attached fixedly to the connection element 92 by means of welding or the like.

The connection element 92 is more particularly adapted for connecting the sealing element 93 and the ring shaped element 94 fixedly or rigidly to the gear wheel 96.

The pawl element 95 is mounted on the gear wheel 96 by means of one attachment means in such a way that it is rotatable between a position in engagement with the interior toothing of the ring-shaped element 94 and a position out of engagement with the interior toothing of the ring-shaped element 94.

Elements 91, 92, 94, 95, 96 and 98 are made of a suitable metal such as iron or steel. The sealing element 93 is made of a suitable abrasion resistant material. The bearing element 97 is made of a material suitable for bearings, such as metal or plastic.

The braking element 90 is, by means of the fastening element 91 and suitable attachment elements such as screws, bolts, rivets or welds, mounted on the platform 2 in such a position that the gear wheel 96 is arranged in engagement with the toothed rack 315, 325 of the rack element 310, 320 of one of the frames 31, 32.

If the platform 2 and thereby the gear wheel 96 moves at a speed exceeding 10 m/minute, the pawl element 95 is automatically brought into engagement with the interior toothing of the ring-shaped element 94 by the centrifugal force exerted by the gear wheel 96 on the pawl element 95. Thereby the gear wheel 96 is blocked due to the fixed or rigid connection between the ring-shaped element 94 and the gear wheel 96, which in turn causes a braking force to be exerted on the platform 2. Thus, the pawl element 95 and the ring shaped element 94 form an internal brake mechanism for the gear wheel 86.

Thus, the invention provides a set of parts for providing a hoist for a scaffold, as well as a hoist built up of such a set of parts, which is adapted for being built together with an existing scaffold by means of standard scaffold parts. Also, it is noted that the set of parts according to the invention may just as well be said to be a set of parts for providing a scaffold hoist.

In the following a method according to the third aspect of the invention will be described.

A hoist 1, 101, 102 for a scaffold according to the second aspect of the invention may be build up by means of a method comprising the steps of:

providing a set of parts according to the first aspect of the invention,

placing the two frames 31, 32 at each of two opposing sides 25, 26 or 27,28 of the platform 2 such that the respective rack element 310, 320 of the two frames 31, 32 extend substantially vertically, and

arranging the platform 2 such that the two gear elements 63, 64 of the platform 2 are brought into engagement with the respective rack element 310, 320 of the two frames 31, 32.

The method for building up a hoist 1, 101, 102 for a scaffold may furthermore comprise any one or more of the following steps, not necessarily performed in the order mentioned:

a step of controlling the movement of the platform 2 synchronously with respect to each of the two frames 31, 32 by means of the motor 4,

a step of providing at least one of the two frames 31, 32 with at least one longitudinal frame element 311, 312, 321, 322 arranged on a side of the rack element 310, 320 and extending substantially parallel with the rack element 310, 320,

a step of providing at least one of the two frames 31, 32 with at least one transversal frame element 313, 323 extending substantially perpendicular to the rack element 310, 320,

a step of providing the hoist 1, 101, 102 with a transmission element 61, 62 extending from the motor 4 to each of the two frames 31, 32,

a step of arranging the motor 4 substantially centrally under the platform 2,

a step of providing the platform 2 with a compartment 24 adapted for accommodating the motor 4, arranging the compartment 24 substantially centrally under the platform 2 and arranging the motor 4 in the compartment 24,

a step of providing the rack element 310, 320 of each of the two frames 31, 32 with a toothed rack 315, 325, and providing each of the gear elements 63, 64 of the platform with a gear 631, 641, the toothed rack 315, 325 and the gear 631, 641 being adapted for mutual engagement, and

a step of providing the rack element 310, 320 of each of the two frames 31, 32 with a first profile element 314, 324 adapted for accommodating the toothed rack 315, 325, and providing each of the gear elements 63, 64 of the platform with a second profile element 630, 640 being adapted for accommodating the gear 631, 641 and for sliding engagement with one of the respective first profile elements 314, 324.

The method for building up a hoist 1, 101, 102 for a scaffold may furthermore comprise a step of providing at least one frame extension element 33, 34 adapted for connection with one of the two frames 31, 32 such as to extend the one of the two frames 31, 32 in the longitudinal direction, and a step of connecting the at least one frame extension element 33, 34 with one of the frames 31, 32.

The method for building up a hoist 1, 101, 102 for a scaffold may furthermore comprise a step of providing a rail element 5 adapted for enclosing the platform 2 and a step of arranging the rail element 5 on the platform 2.

The method for building up a hoist 1, 101, 102 for a scaffold may furthermore comprise a step of providing at least one first supporting element 71, 72 adapted for extending between the two frames 31 and 32 and a step of attaching the at least one first supporting element 71, 72 between the two frames 31 and 32.

The method for building up a hoist 1, 101, 102 for a scaffold may furthermore comprise a step of providing at least one second supporting element 73 adapted for extending between one of the two frames 31, 32 and a base 9 on which the two frames 31, 32 are arranged and a step of arranging the at least one second supporting element 73 such that one end is attached to one of the two frames 31 and 32 and another end is abutting the basis 9.

The method for building up a hoist 1, 101, 102 for a scaffold may furthermore comprise a step of providing at least one wheel 74, 75, 76, 77 adapted for connection with one of the two frames 31, 32 and for rolling on a base 9 on which the two frames 31, 32 are arranged and a step of connecting the at least one wheel 74, 75, 76, 77 to one of the two frames 31 and 32.

The method for building up a hoist 1, 101, 102 for a scaffold may furthermore comprise the step of providing a braking element 90 adapted for braking the movement of the platform 2 along the longitudinal direction L of the two frames when the speed of the platform 2 exceeds a predefined threshold, the braking element being of the type comprising a gear wheel 96 with an internal brake mechanism 94, 95, and a step of connecting the braking element 90 to the platform 2 in such a way that the gear wheel 96 of the braking element 90 is in engagement with the toothed rack 314, 324 of the rack element 310, 320 of one of the frames 31 and 32.

The method for building up a hoist 1, 101, 102 for a scaffold may furthermore comprise the step of providing a door element 80 which comprises a first part 81 and a second part 82, the second part 82 being arranged in the first part 81 such as to be telescopically slidable with respect to the first part 81 between a collapsed position and an extended position and the second part 82 being biased towards the extended position with a biasing force of between 40 and 50 N, and a step or arranging the door element 80 on the platform 2 as a part of a rail element 5.

It should be noted that the above description of preferred embodiments serves only as examples, and that a person skilled in the art will know that numerous variations are possible without deviating from the scope of the claims.

1. A set of parts for providing a hoist for a scaffold, the set of parts comprising:
a platform adapted for carrying at least one object and comprising at least two gear elements, the at least two gear elements being arranged at each of two opposing sides of the platform,
two frames adapted for being arranged at each of the two opposing sides of the platform, the two frames each comprising one rack element arranged extending in a longitudinal direction of the frame, and
one motor for moving the platform along a longitudinal direction of the two frames and for controlling the movement of the platform synchronously with respect to each of the two frames,
the rack element of each of the two frames comprising a toothed rack, and each of the gear elements of the platform comprising a gear, the toothed rack and the gear being adapted for mutual engagement, and wherein
the rack element of each of the two frames comprises a first profile element adapted for accommodating the toothed rack, and each of the gear elements of the platform comprises a second profile element being adapted for accommodating the gear and for sliding engagement with one of the respective first profile elements.

2. A set of parts according to claim 1, wherein the motor is attached to the platform and wherein the platform further comprises a transmission element for driving each of the at least two gear elements, the transmission element extending from the motor and being connected to each of the at least two gear elements.

3. A set of parts according to claim 1, wherein the one rack element of each of the two frames is arranged centrally on the frame.

4. A set of parts according to claim 1, wherein at least one of the two frames comprise any one or more of:
at least one longitudinal frame element arranged by a side of the rack element and extending substantially parallel with the rack element, and
at least one transversal frame element extending substantially perpendicular to the rack element.

5. A set of parts according to claim 1, wherein the platform further comprises a compartment adapted for accommodating the motor, the compartment being arranged substantially centrally under the platform.

6. A set of parts according to claim 1, and further comprising a braking element adapted for braking the movement of the platform along the longitudinal direction of the two frames when the speed of the platform exceeds a predefined threshold, the braking element being of the type comprising a gear wheel with an internal brake mechanism.

7. A set of parts according to any one of the above claims, and further comprising any one or more of:
a rail element adapted for enclosing the platform,
at least one frame extension element adapted for connection with one of the two frames such as to extend the one of the two frames in the longitudinal direction,
at least one first supporting element adapted for extending between the two frames,
at least one second supporting element adapted for extending between one of the two frames and a base on which the two frames are arranged, and
at least one wheel adapted for connection with one of the two frames and for rolling on a base on which the two frames are arranged.

8. A set of parts according to any one of the above claims, wherein the motor is arranged centrally under the platform.

9. A set of parts according to claim 1, wherein the transmission element is a transmission rod, the transmission rod being any one of one common rod and two separate rods.

10. A hoist for a scaffold built up of a set of parts according to any one of the above claims, the hoist comprising:
a platform adapted for carrying at least one object and comprising at least two gear elements, the at least two gear elements being arranged at each of two opposing sides of the platform,
two frames each comprising one rack element arranged extending in a longitudinal direction of the frame, the two frames being arranged at each of the two opposing sides of the platform such that the rack element of each of the at least two frames is in mutual engagement with at least one of the at least two gear elements, and
one motor for moving the platform along a longitudinal direction of the two frames, the motor being connected to the at least two gear elements of the platform such as to control the movement of the platform synchronously with respect to each of the two frames.

11. A method for building up a hoist for a scaffold, the method comprising the steps of:
providing a set of parts according to any one of claims 1-10,
placing the two frames at each of two opposing sides of the platform such that the respective rack element of the two frames extend vertically, and
arranging the platform such that the two gear elements of the platform are brought into engagement with the respective rack element of the two frames.

12. A set of parts according to claim 1, and further comprising a rail element adapted for enclosing the platform and comprising a door element which comprises a first part and a second part, the second part being arranged in the first part such as to be telescopically slidable with respect to the first part between a collapsed position and an extended position and the second part being biased towards the extended position with a biasing force of between 40 and 50 N.
